(19) United States
(12) Patent Application Publication
(10) Pub. No.: US 2010/0048138 A1
(43) Pub. Date: Feb. 25, 2010

(54) COMMUNICATION DEVICE

(75) Inventor: Ichiro TOMODA, Tokyo (JP)

Correspondence Address: PATTERSON & SHERIDAN, L.L.P., 3040 POST OAK BOULEVARD, SUITE 1500, HOUSTON, TX, 77056, US

(73) Assignee: Kabushiki Kaisha Toshiba, Tokyo (JP)

(21) Appl. No.: 12/400,247

(22) Filed: Mar. 9, 2009

(30) Foreign Application Priority Data
Aug. 21, 2008 (JP) 2008212450

(51) Int. Cl. H04B 7/00; H04R 3/00

(52) U.S. Cl. 455/66.1; 381/122

(57) ABSTRACT

According to an aspect of the present invention, there is provided a communication device including: an audio signal input member configured to receive a first audio signal; a high-frequency coupler configured to receive a second audio signal, the second audio signal based on a high-frequency signal transmitted from an external high-frequency coupler by communicating with the external high-frequency coupler through electric field coupling; an output unit configured to output one of the first audio signal and the second audio signal; and a switch configured to switch an output of the output unit between the first audio signal and the second audio signal based on a status of communication between the high-frequency coupler and the external high-frequency coupler.

### CROSS-REFERENCE TO RELATED APPLICATIONS

This application is based upon and claims the benefit of priority from Japanese Patent Application No. 2008-212450, filed on Aug. 21, 2008, the entire contents of which are incorporated herein by reference.

### BACKGROUND

1. Field

An aspect of the present invention relates to communication device.

2. Description of the Related Art

Communication devices are known which receive an audio signal from a mobile phone that is equipped with an induction coil (see JP-A-2007-325042, for instance).

A communication device of this kind is equipped with a telephone coil for receiving an audio signal from a mobile phone, an amplifier for amplifying the signal received by the telephone coil, and a speaker for converting the signal amplified by the amplifier into a voice and outputting it. When a mobile phone having an induction coil is brought into close proximity to the communication device, the telephone coil is magnetically coupled with the induction coil, whereby an audio signal of the mobile phone can be output from the speaker of the communication device. If this type of communication device is applied to, for example, a hearing aid, a user can make a call while wearing the hearing aid.

However, when a communication device of the above kind is applied to a hearing aid, a signal input from a functional unit of the hearing aid and a signal input from the telephone coil are superimposed and amplified in the amplifier, and then converted by the speaker, as a result of which an audio including two input superimposed each other is output from the speaker. Therefore, it may be difficult for a user to distinguish two original voices from each other.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is a schematic view showing an example configuration of a communication system according to a first embodiment;

FIG. 2 is a sectional view showing an example configuration of a first communication device according to the first embodiment;

FIG. 3 is a block diagram showing an example configuration of the first communication device according to the first embodiment;

FIG. 4 is a block diagram showing an example configuration of a second communication device according to the first embodiment;

FIG. 5 is a schematic view showing an example operation of the communication devices according to the first embodiment;

FIG. 6A is an exemplary flowchart showing the operation of the first communication device according to the first embodiment;

FIG. 6B is an exemplary flowchart showing the operation of the second communication device according to the first embodiment;

FIG. 7 is a schematic view showing an example configuration of a communication system according to a second embodiment;

FIG. 8 is a block diagram showing an example configuration of a third communication device according to the second embodiment;

FIG. 9 is a block diagram showing an example configuration of a fourth communication device according to the second embodiment;

FIG. 10 is a schematic view showing an example operation of the communication devices according to the second embodiment;

FIG. 11A is an exemplary flowchart showing the operation of the third communication device according to the second embodiment; and

FIG. 11B is an exemplary flowchart showing the operation of the fourth communication device according to the second embodiment.

### DETAILED DESCRIPTION

Various embodiments according to the present invention will be described hereinafter with reference to the accompanying drawings. In general, according to one embodiment of the present invention, there is provided a communication device including: an audio signal input member configured to receive a first audio signal; a high-frequency coupler configured to receive a second audio signal, the second audio signal based on a high-frequency signal transmitted from an external high-frequency coupler by communicating with the external high-frequency coupler through electric field coupling; an output unit configured to output one of the first audio signal and the second audio signal; and a switch configured to switch an output of the output unit between the first audio signal and the second audio signal based on a status of communication between the high-frequency coupler and the external high-frequency coupler.

Communication devices according to embodiments of the present invention will be hereinafter described in detail with reference to the drawings.

### First Embodiment

(Configuration of Communication System)

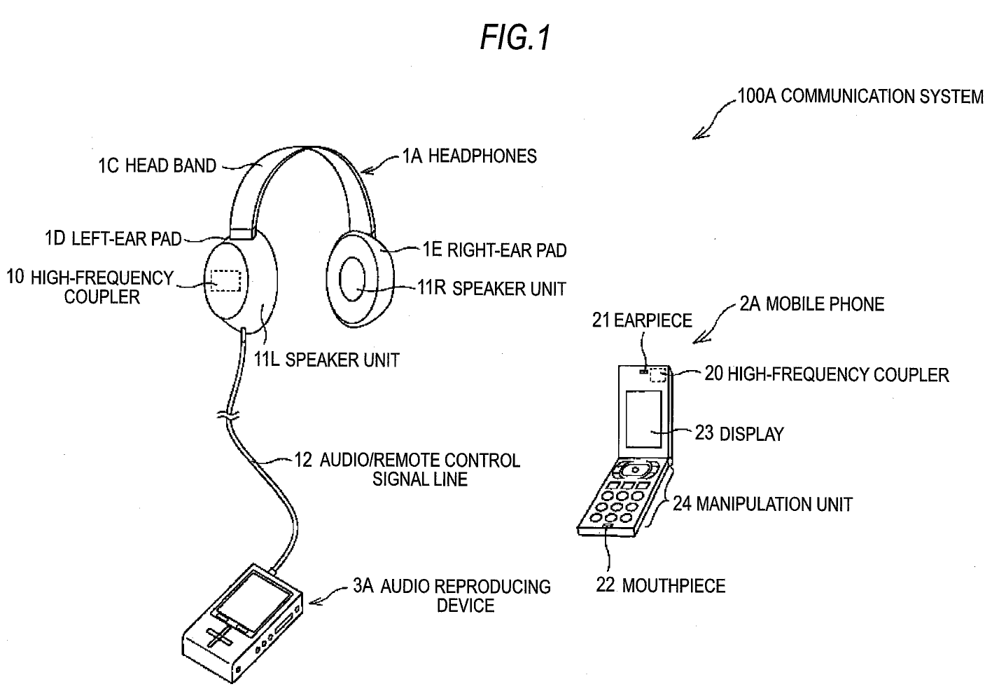

FIG. 1 is a schematic view showing an example configuration of a communication system according to a first embodiment.

A communication system 100A is configured of headphones 1A which output a voice when connected to an audio reproducing device 3A and also function as a communication device and a mobile phone 2A which functions as not only a mobile phone but also a communication device.

The headphones 1A are equipped with a left-ear pad 1D to be attached to the left ear of a user, a right-ear pad 1E to be attached to the right ear of the user, and a head band 1C which connects the left-ear pad 1D and the right-ear pad 1E mechanically and electrically. And the headphones 1A are connected to the audio reproducing device 3A via an audio/remote control signal line 12. The left-ear pad 1D is equipped with a high-frequency coupler 10 for communicating with an external device through electric field coupling by a high-frequency signal, a speaker unit 11L as an output unit for outputting a sound or voice, and the audio/remote control signal line 12 as an input member. The right-ear pad 1E is equipped with a speaker unit 11R as an output unit for outputting a sound or voice.

The mobile phone 2A is equipped with a high-frequency coupler 20 for communicating with the high-frequency coupler 10; an earpiece 21 which incorporates a speaker and serves as an output unit for outputting a voice of an intended party when the mobile phone 2A functions as a mobile phone; a mouth piece which incorporates a microphone and serves as an input unit for receiving a voice to be transmitted to the intended party when the mobile phone 2A functions as a mobile phone; a display 23 for displaying a text, an image, or the like; and a manipulation unit 24 including plural switches.

In the embodiment, it is assumed that the high-frequency coupler 10 of the headphones 1A and the high-frequency coupler 20 of the mobile phone 2A can communicate with each other when they are as close to each other as 3 cm or less, for example, and that authentication processing such as pairing or coding of a communication signal is not performed at a start of a communication.

The audio reproducing device 3A, which is, for example, an MPEG audio layer-3 (MP3) player having a hard disk drive (HDD), a flash memory, or the like, outputs an audio signal to the headphones 1A via the audio/remote control signal line 12.

(Configuration of Communication Devices)

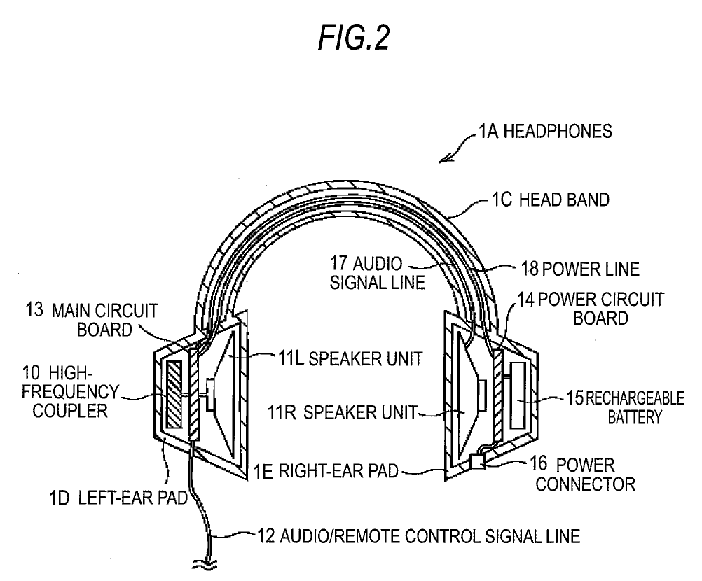

FIG. 2 is a sectional view showing an example configuration of a first communication device (headphones 1A) according to the first embodiment.

The left-ear pad 1D of the headphones 1A is equipped with the high-frequency coupler 10, the speaker unit 11L, the audio/remote control signal line 12, and a main circuit board 13 which is mounted with electronic components such as a memory and a central processing unit (CPU) for controlling operation of the headphones 1A. The right-ear pad 1E is equipped with the speaker unit 11R, a power circuit board 14 for controlling power supply of the headphones 1A, a rechargeable battery 15 such as a lithium-ion battery which is chargeable and dischargeable, and a power connector 16 to which a power source adapter for supplying power is connected in charging the rechargeable battery 15. The head band 1C is equipped, inside itself, with an audio signal line 17 which electrically connects the main circuit board 13 to the speaker unit 11R and transmits an audio signal to the latter, and a power line 18 which electrically connects the power circuit board 14 to the main circuit board 13 and supplies power to the latter.

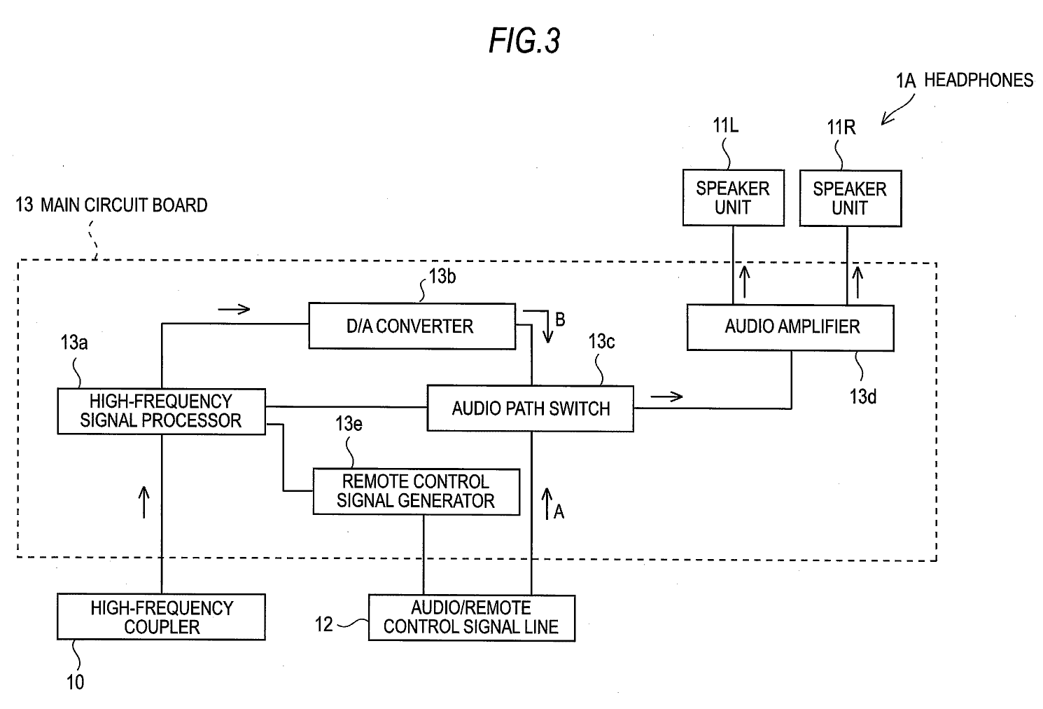

FIG. 3 is a block diagram showing the example configuration of the first communication device according to the first embodiment.

The main circuit board 13 of the headphones 1A is equipped with a high-frequency signal processor 13a which is connected to the high-frequency coupler 10 and encodes and decodes a high-frequency signal; a D/A converter 13b for converting a digital audio signal into an analog audio signal; an audio path switch 13c for switching output between an input signal A (first audio signal) from the audio/remote control signal line 12 and an input signal B (second audio signal) from the D/A converter 13b based on output from the high-frequency signal processor 13a; an audio amplifier 13d as an audio signal processor for amplifying an output audio signal of the audio path switch 13c and outputs resulting signals to the speaker units 11L and 11R; and a remote control signal generator 13e for generating a remote control signal under the control of the high-frequency signal processor 13a and transmitting it through the audio/remote control signal line 12.

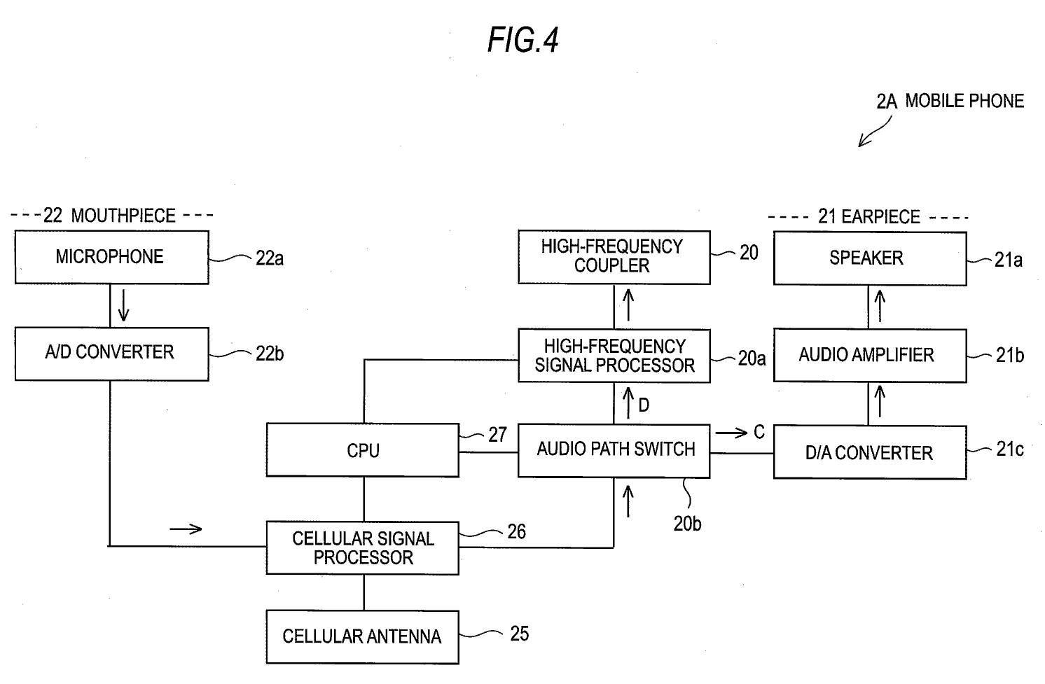

FIG. 4 is a block diagram showing an example configuration of a second communication device (mobile phone 2A) according to the first embodiment.

The mobile phone 2A is configured of the high-frequency coupler 20; a high-frequency signal processor 20a which is connected to the high-frequency coupler 20 and encodes and decodes a high frequency signal; an audio path switch 20b for switching the output between an output signal C (fourth audio signal) to a D/A converter 21c and an output signal D (fifth audio signal) to the high-frequency signal processor 20a; a speaker 21a which is incorporated in the earpiece 21; an audio amplifier 21b for amplifying an audio signal received from a D/A converter 21c and outputs a resulting signal to the speaker 21a; the D/A converter 21c for converting a digital audio signal received from the audio path switch 20b into an analog signal; a microphone 22a which is incorporated in the mouthpiece 22; an A/D converter 22b for converting an analog audio signal (third audio signal) received from the microphone 22a into a digital signal; a cellular antenna 25 for transmitting and receiving mobile phone radio waves; a cellular signal processor 26 as a mobile phone signal processor which functions to enable a communication with a distant user by means of radio waves transmitted and received by the cellular antenna 25; and a CPU 27 for controlling the individual sections.

(Operation)

The operation of the communication devices according to the first embodiment will be described below with reference to the drawings.

In the state shown in FIG. 1, the audio reproducing device 3A reproduces, for example, audio information that is stored in a storage unit provided in the main body and outputs a resulting audio signal. The headphones 1A receive the audio signal that is output from the audio reproducing device 3A via the audio/remote control signal line 12, processes it with the audio path switch 13c and the audio amplifier 13d in this order, and outputs sounds through the speaker units 11L and 11R.

In this case, not detecting establishment of a communication with an external device, the high-frequency signal processor 13a controls the audio path switch 13c to set the input to the audio path switch 13c to an input signal A from the audio/remote control signal line 12.

Where the mobile phone 2A is used independently, an audio signal output from the cellular signal processor 26 is sequentially processed by the audio path switch 20b, the D/A converter 21c, and the audio amplifier 21b, and then output from the speaker 21a.

An audio signal to be input to the cellular signal processor 26 of the mobile phone 2A is processed by the microphone 22a and the A/D converter 22b in this order.

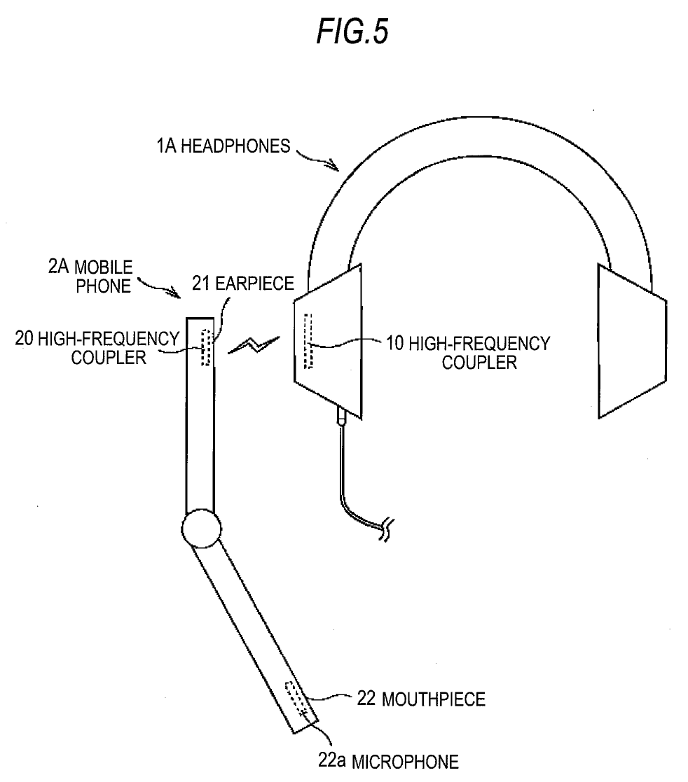

FIG. 5 is a schematic view showing an example operation of the communication devices according to the first embodiment.

When a call arrives at the mobile phone 2A or a call is initiated by the mobile phone 2A in the state shown in FIG. 5, the user brings the earpiece 21 of the mobile phone 2A close to the left-ear pad 1D of the headphones 1A. Since the mobile phone 2A and the headphones 1A are close to each other, the high-frequency couplers 10 and 20 come as close to each other as 3 cm or less, for example, whereby a communication is established and an audio signal is transmitted.

In this case, when detecting the establishment of a communication between the high-frequency couplers 10 and 20, the high-frequency signal processor 13a controls the audio path switch 13c to set the input to the audio path switch 13c as an input signal B from the D/A converter 13b. Furthermore, the high-frequency signal processor 13a controls the remote signal generator 13e to send a signal for stopping the reproduction to the audio reproducing device 3A.

At this time, when detecting the establishment of a communication between the high-frequency couplers 10 and 20, the high-frequency signal processor 20a controls the audio path switch 20b to set the output from the audio path switch 20b to an output signal D to the high-frequency signal processor 20a.

As a result, an audio signal that is output from the cellular signal processor 26 of the mobile phone 2A is sequentially processed by the audio path switch 20b, the high-frequency signal processor 20a, the high-frequency coupler 20, the high-frequency coupler 10, the high-frequency signal processor 13a, the D/A converter 13b, the audio path switch 13c, and the audio amplifier 13d, and then output from the speaker units 11L and 11R.

An audio signal to be input to the cellular signal processor 26 of the mobile phone 2A is processed by the microphone 22a and the A/D converter 22b in this order.

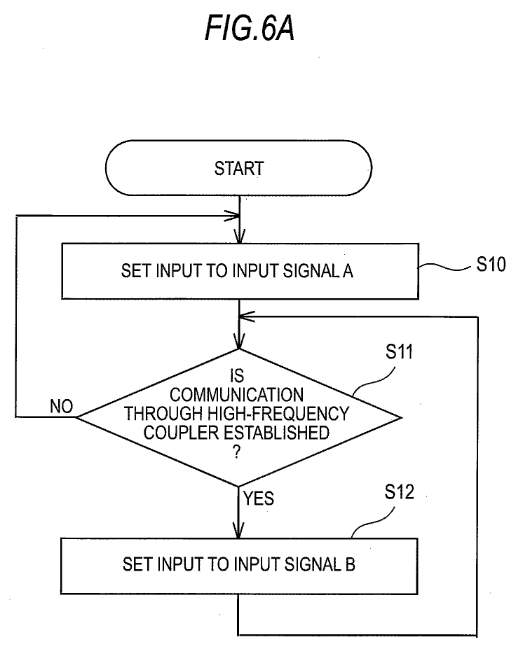

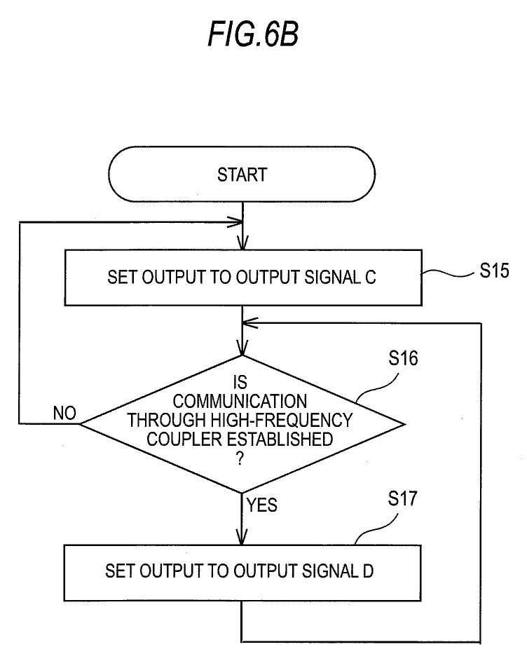

FIG. 6A is an exemplary flowchart showing the operation of the first communication device according to the first embodiment.

First, during ordinary use, at step S10 the high-frequency signal processor 13a controls the audio path switch 13c to set the input to the audio path switch 13c to an input signal A, that is, an audio signal that is input through the audio/remote control signal line 12.

Then, the high-frequency signal processor 13a monitors the status of the high-frequency coupler 10. When detecting establishment of a communication with the external high-frequency coupler 20 (S11: yes), at step S12 the high-frequency signal processor 13a sets the input to the audio path switch 13c to an input signal B, that is, an audio signal that is input from the D/A converter 13b.

When establishment of a communication through the high-frequency coupler 10 is not detected (S11: no), the process returns to step S10, where the input to the audio path switch 13c is set to an input signal A.

FIG. 6B is an exemplary flowchart showing the operation of the second communication device according to the first embodiment.

First, during ordinary use, at step S15 the high-frequency signal processor 20a sets the output of the audio path switch 20b to an output signal C, that is, an audio signal to be output to the D/A converter 21c.

Then, the high-frequency signal processor 20a monitors the status of the high-frequency coupler 20. When detecting establishment of a communication with the external high-frequency coupler 10 (S16: yes), at step S17 the high-frequency signal processor 20a sets the output of the audio path switch 20b to an output signal D, that is, an audio signal to be output to the high-frequency signal processor 20a.

When establishment of a communication through the high-frequency coupler 20 is not detected (S16: no), the process returns to step S15, where the output of the audio path switch 20b is set to an output signal C.

(Advantages of First Embodiment)

In the above-described embodiment, when the mobile phone 1A is held close to the left-ear pad 1D of the headphones 1A, that is, when the high-frequency coupler 10 of the headphones 1A and the high-frequency coupler 20 of the mobile phone 2A have established a communication, the audio path switches 13c and 20b switch the audio signal input and output, respectively. This allows a user to easily distinguish between a voice from the mobile phone 2A and a sound from the audio reproducing device 3A through the headphones 1A. That is, the user can use the mobile phone 2A and the audio reproducing device 3A while wearing the headphones 1A.

Since the high-frequency couplers 10 and 20 do not perform authentication processing such as pairing or coding, no operation for establishment of a connection needs to be performed in switching between the mobile phone 2A and the audio reproducing device 3A, accordingly, time required for the switching can be shortened. Since a communication can be made without registration between devices, the operation according to the embodiment can be performed between arbitrary devices.

Since the high-frequency couplers 10 and 20 start a communication when they are brought close to one ear of a user, the sense of manipulation of the mobile phone 2A is not impaired.

When a communication through the high-frequency coupler 10 finishes, the high-frequency signal processor 13a may control the remote control signal generator 13e to send a signal for restarting reproduction of audio information to the audio-reproducing device 3A.

A communication between the headphones 1A and the audio reproducing device 3A may be a radio communication using Bluetooth (registered trademark), a wireless LAN, or the like rather than a wired communication using the audio/remote control signal line 12.

### Second Embodiment

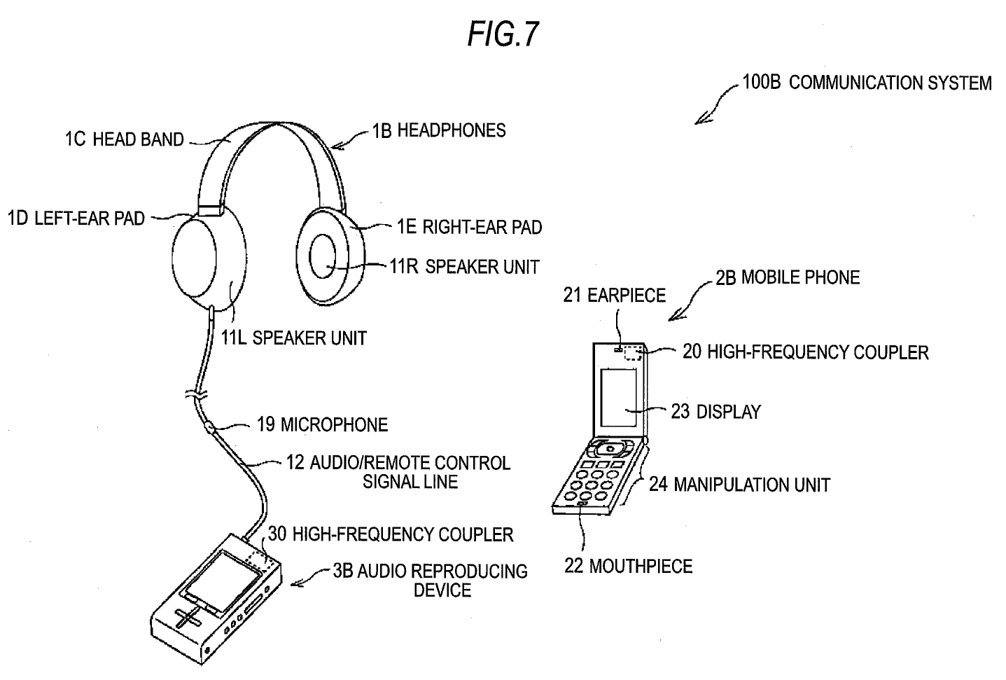

FIG. 7 is a schematic view showing an example configuration of a communication system according to a second embodiment. A component having the same structure or function as a corresponding component in the first embodiment will be given the same reference symbol as the latter.

The audio/remote control signal line 12 of headphones 1B has a microphone 19 for collecting a voice of a user of the headphones 1B and outputs a resulting audio signal. The headphones 1B are different from the headphones 1A in not having the high-frequency coupler 10.

An audio reproducing device 3B as a communication device is equipped with a high-frequency coupler 30 for communicating with the high-frequency coupler 20.

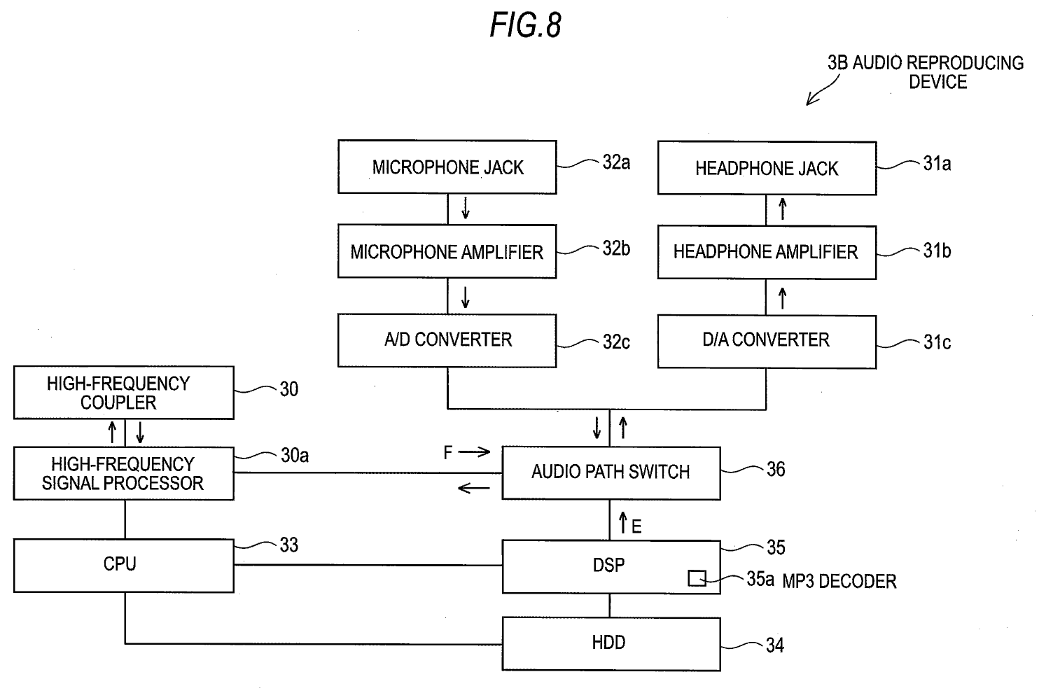

FIG. 8 is a block diagram showing an example configuration of a third communication device (audio reproducing device 3B) according to the second embodiment.

The audio reproducing device 3B is equipped with the high-frequency coupler 30; a high-frequency signal processor 30a which is connected to the high-frequency coupler 30 and encodes and decodes a high-frequency signal; a headphone jack 31a as an output terminal which is connected to the headphones 1B; a headphone amplifier 31b for amplifying an audio signal to be output according to the characteristics of the headphones 1B; a D/A converter 31c for converting a digital audio signal that is input from an audio path switch 36 into an analog audio signal; a microphone jack 32a as an input terminal which is connected to the microphone 19 of the headphones 1B; a microphone amplifier 32b for amplifying an audio signal that is input from the microphone 19; an A/D converter 32c for converting an analog audio signal that is input from the microphone amplifier 32b into a digital audio signal; a CPU 33 for controlling the individual sections; an HDD 34 for storing audio information; a digital signal processor (DSP) 35 for causing an MP3 decoder 35a to operate, the MP3 decoder 35a being an audio information reproduction processor for decoding audio information stored in the HDD 34 and performing signal processing on a resulting signal; and the audio path switch 36 for switching the input between an input signal E (seventh audio signal) from the DSP 35 and an input signal F (eighth audio signal) from the high-frequency signal processor 30a.

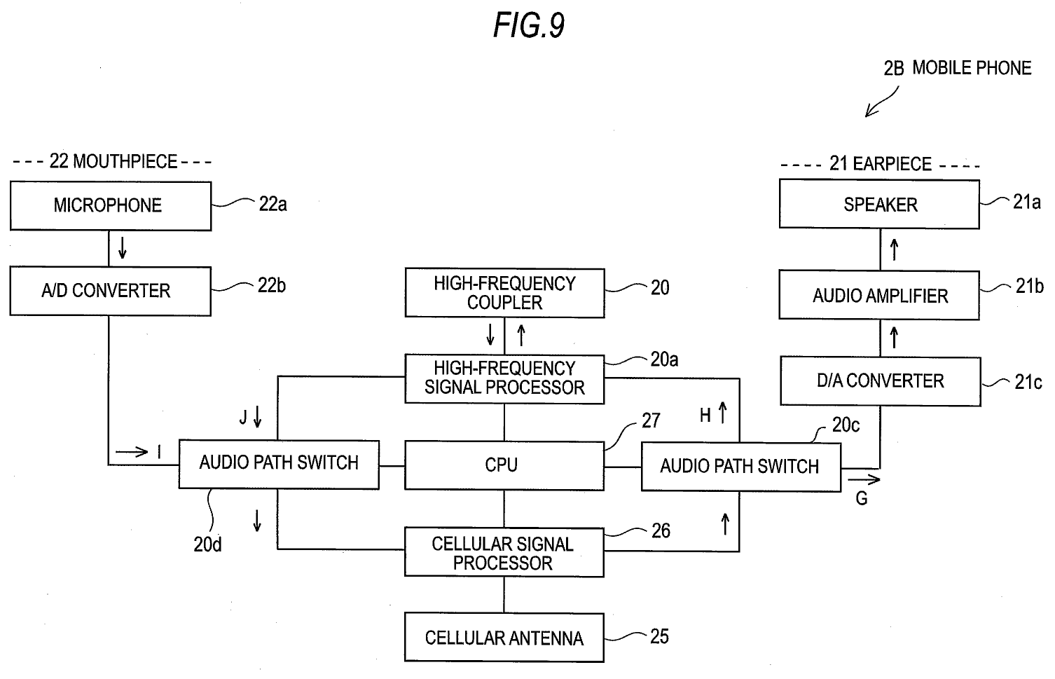

FIG. 9 is a block diagram showing an example configuration of a fourth communication device (mobile phone 2B) according to the second embodiment.

The mobile phone 2B is equipped with an audio path switch 20d for switching the input between an input signal I (third audio signal) from the A/D converter 22b and an input signal J (sixth audio signal) from the high-frequency signal processor 20a and an audio path switch 20c for switching the output between an output signal G (fourth audio signal) to the D/A converter 21c and an output signal H (fifth audio signal) to the high-frequency signal processor 20a.

(Operation)

The operation of the communication devices according to the second embodiment will be described below with reference to the drawings.

In the state shown in FIG. 7, the audio reproducing device 3B reproduces audio information of the HDD 34 with the MP3 decoder 35a of the DSP 35, processes a resulting audio signal with the audio path switch 36, the D/A converter 31c, and the headphone amplifier 31b in this order, and outputs the thus-processed audio signal from the headphone jack 31a. The headphones 1B receive, via the audio/remote control signal line 12, the audio signal that is output from the headphone jack 31a of the audio reproducing device 3B, process it with the audio path switch 13c and the audio amplifier 13d in this order, and output sounds through the speaker units 11L and 11R.

In this case, not detecting establishment of a communication with an external device, the high-frequency signal processor 30a controls the audio path switch 36 to set the input to the audio path switch 36 to an input signal E from the DSP 35.

When the mobile phone 2B is used independently, an audio signal output from the cellular signal processor 26 is sequentially processed by the audio path switch 20c, the D/A converter 21c, and the audio amplifier 21b, and then output from the speaker 21a.

An audio signal to be input to the cellular signal processor 26 of the mobile phone 2B is processed by the microphone 22a and the A/D converter 22b in this order.

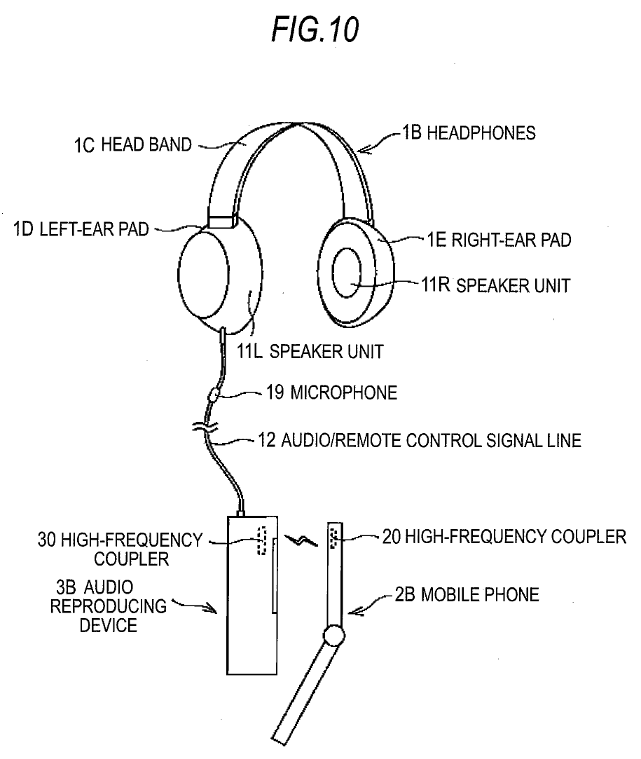

FIG. 10 is a schematic view showing an example operation of the communication devices according to the second embodiment.

When a call arrives at the mobile phone 2B or a call is initiated by the mobile phone 2B in the state shown in FIG. 7, the user brings the mobile phone 2A close to the audio reproducing device 3B. A communication is started when the high-frequency couplers 20 and 30 come as close to each other as 3 cm or less.

In this case, when detecting the establishment of a communication, the high-frequency signal processor 30a controls the audio path switch 36 to switch the input to the audio path switch 36 from an input signal E from the DSP 35 to an input signal F from the high-frequency signal processor 30a. Furthermore, the audio path switch 36 inputs an audio signal that has been processed by the microphone jack 32a, the microphone amplifier 32b, and the A/D converter 32c in this order to the high-frequency signal processor 30a.

At this time, when detecting the establishment of a communication, the high-frequency signal processor 20a controls the audio path switch 20c to set the output from the audio path switch 20c to an output signal H to the high-frequency signal processor 20a. Furthermore, the high-frequency signal processor 20a controls the audio path switch 20d to set the input to the audio path switch 20d to an input signal J from the high-frequency signal processor 20a. The cellular signal processor 26 may receive a speech signal of the call at the time of the switching of the audio path switch 20d.

As a result of the above operation, an audio signal that is output from the cellular signal processor 26 of the mobile phone 2B is processed by the audio path switch 20c, the high-frequency signal processor 20a, the high-frequency coupler 20, the high-frequency coupler 30, the high-frequency signal processor 30a, the audio path switch 36, the D/A converter 31c, and the headphone amplifier 31b in this order, and a resulting audio signal is output from the headphone jack 31a. The audio signal that is output from the headphone jack 31a is output as a voice through the speaker units 11L and 11R of the headphones 1B.

An audio signal to be input to the cellular signal processor 26 of the mobile phone 2B is processed by the microphone 19 of the headphones 1B, the audio/remote control signal line 12, the microphone jack 32a, the microphone amplifier 32b, the A/D converter 32c, audio path switch 36, the high-frequency signal processor 30a, the high-frequency coupler 30, the high-frequency coupler 20, the high-frequency signal processor 20a, and the audio path switch 20d in this order.

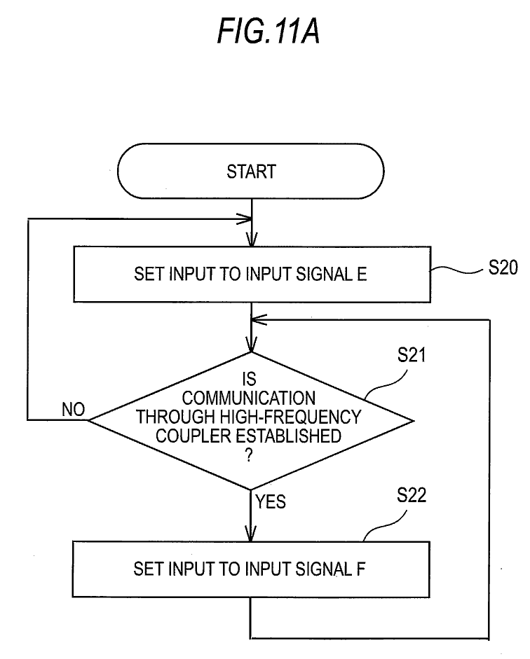

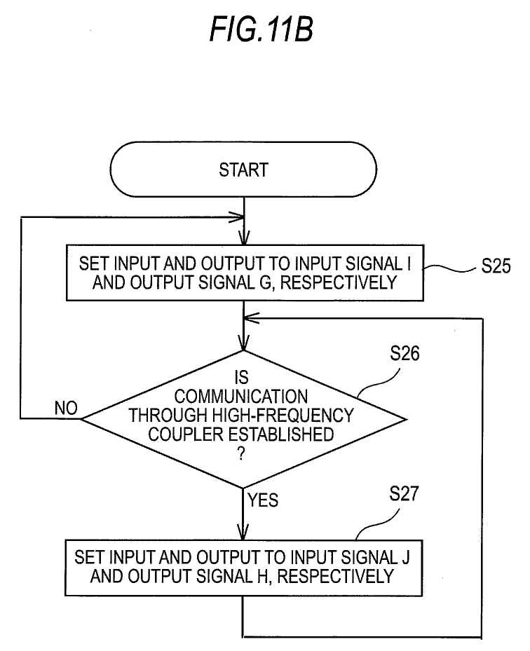

FIG. 11A is an exemplary flowchart showing the operation of the third communication device according to the second embodiment.

First, during ordinary use, at step S20 the high-frequency signal processor 30a controls the audio path switch 36 to set the input to the audio path switch 36 to an input signal E, that is, an audio signal that is input from the DSP 35.

Then, the high-frequency signal processor 30a monitors the status of the high-frequency coupler 30. When detecting establishment of a communication with the external high-frequency coupler 20 (S21: yes), at step S22 the high-frequency signal processor 30a sets the input to the audio path switch 36 to an input signal F, that is, an audio signal that is input from the high-frequency signal processor 30a.

When establishment of a communication through the high-frequency coupler 30 is not detected (S21: no), the process returns to step S20, where the input to the audio path switch 36 is set to an input signal E.

FIG. 11B is an exemplary flowchart showing the operation of the fourth communication device according to the second embodiment.

First, during ordinary use, at step S25 the high-frequency signal processor 20a sets the input of the audio path switch 20d to an input signal I, that is, an audio signal that is input from the A/D converter 22b, and sets the output of the audio path switch 20c to an output signal G, that is, an audio signal to be output to the D/A converter 21c.

Then, the high-frequency signal processor 20a monitors the status of the high-frequency coupler 20. When detecting establishment of a communication with the external high-frequency coupler 10 (S26: yes), at step S27 the high-frequency signal processor 20a sets the input to the audio path switch 20d to an input signal J, that is, an audio signal that is input from the high-frequency signal processor 20a, and sets the output of the audio path switch 20c to an output signal H, that is, an audio signal to be output to the high-frequency signal processor 20a.

When establishment of a communication through the high-frequency coupler 20 is not detected (S26: no), the process returns to step S25, where the input to the audio path switch 20d is set to an input signal I and the output of the audio path switch 20c is set to an output signal G.

(Advantages of Second Embodiment)

In the above-described embodiment, when the mobile phone 1B is held close to the audio reproducing device 3B, that is, when the high-frequency coupler 30 of the audio reproducing device 3B and the high-frequency coupler 20 of the mobile phone 2B have established a communication, the audio path switches 20c and 20d switch the audio signal output and input, respectively, and the audio path switch 36 switches the audio signal input. This allows a user to easily distinguish between voice from the mobile phone 2B and a sound from the audio reproducing device 3B through the headphones 1B. That is, the user can use the mobile phone 2B and the audio reproducing device 3B while wearing the headphones 1B.

The headphones 1B may be arbitrary headphones as long as they are equipped with speakers and a microphone. The pair of speakers and the microphone may be connected as separate members.

A communication may be configured in such a manner that the high-frequency coupler 30, the high-frequency signal processor 30a, and the audio path switch 36 of the audio reproducing device 3B are made independent of the remaining part and implemented as a separate dongle that can be connected to the remaining part. This makes it possible to give a general-purpose audio reproducing device a communication function and an audio path switching function. The similar sections of the mobile phone 2B may be made separately.

(1) A first aspect of the invention provides a communication device including: an audio signal input member configured to receive a first audio signal; a high-frequency coupler configured to receive a second audio signal, the second audio signal based on a high-frequency signal transmitted from an external high-frequency coupler by communicating with the external high-frequency coupler through electric field coupling; an output unit configured to output the first audio signal or the second audio signal; and a switch configured to switch the output of the output unit between the first audio signal and the second audio signal based on a status of communication between the high-frequency coupler and the external high-frequency coupler.

With this configuration, when the high-frequency coupler has started to communicate with an external device, the audio signal input source is switched from the audio signal input member to the high-frequency coupler. Therefore, the audio signal output from the output unit is not audio signals that are superimposed each other. This allows a user to recognize the output audio signal properly.

(2) A second aspect of the invention provides a communication device including a microphone configured to receive a third audio signal; a speaker configured to output a fourth audio signal; a high-frequency coupler configured to convert a fifth audio signal into a high-frequency signal and to transmit the high-frequency signal by communicating with an external high-frequency coupler through electric field coupling; an audio signal processor configured to transmit the third audio signal as a speech signal to outside the communication device, the audio signal processor configured to reproduce an incoming speech signal received externally and output the reproduced speech signal as the fourth audio signal or the fifth audio signal; and a switch configured to switch the output of the audio signal processor between the fourth audio signal and the fifth audio signal based on a status of communication between the high-frequency coupler and the external high-frequency coupler.

With this configuration, when the high-frequency coupler has started to communicate with an external device, the output destination of an audio signal produced by reproducing a speech signal by the audio signal processor is switched from the speaker to the high-frequency coupler. This allows the external device having a high-frequency coupler to output an audio signal based on the speech signal.

(3) A third aspect of the invention provides a communication device including: an audio signal processor configured to generate a seventh audio signal by reproducing audio information; a high-frequency coupler configured to receive an eighth audio signal, the eighth audio signal based on a high-frequency signal transmitted from an external high-frequency coupler by communicating with the external high-frequency coupler through electric field coupling; an audio signal output section configured to output the seventh audio signal or the eighth audio signal; and a switch configured to switch the output of the audio signal output section between the seventh audio signal and the eighth audio signal based on a status of communication between the high-frequency coupler and the external high-frequency coupler.

With this configuration, when the high-frequency coupler has started to communicate with an external device, the audio signal output of the audio signal output section is switched from an audio signal reproduced by and output from the audio signal processor to an audio signal received by the high-frequency coupler. This allows the audio signal output section to output an audio signal to be reproduced by the external device having a high-frequency coupler.

One aspect of the invention makes it possible to input or output plural kinds of audio signals selectively according to a use situation of the communication device.

What is claimed is:

1. A communication device comprising:
an audio signal input member configured to receive a first audio signal;
a high-frequency coupler configured to receive a second audio signal, the second audio signal based on a high-frequency signal transmitted from an external high-frequency coupler by communicating with the external high-frequency coupler through electric field coupling;
an output unit configured to output one of the first audio signal and the second audio signal; and
a switch configured to switch an output of the output unit between the first audio signal and the second audio signal based on a status of communication between the high-frequency coupler and the external high-frequency coupler.

2. The communication device of claim 1, wherein the switch is configured to switch the output to the second audio signal when the high-frequency coupler and the external high-frequency coupler communicates with each other, and wherein the switch is configured to switch the output to the first audio signal when the high-frequency coupler and the external high-frequency coupler do not communicate with each other.

3. A communication device comprising:
a microphone configured to receive a third audio signal;
a speaker configured to output a fourth audio signal;
a high-frequency coupler configured to communicate with an external high-frequency coupler through electric field coupling by converting a fifth audio signal into a high-frequency signal and transmitting the high-frequency signal;
an audio signal processor configured to transmit the third audio signal to outside the communication device, the audio signal processor configured to reproduce an incoming signal to output one of the fourth audio signal and the fifth audio signal; and
a switch configured to switch an output of the audio signal processor between the fourth audio signal and the fifth audio signal based on a status of communication between the high-frequency coupler and the external high-frequency coupler.

4. The communication device of claim 3, wherein:
the high-frequency coupler is configured to receive a sixth audio signal, the sixth audio signal based on a high-frequency signal transmitted from the external high-frequency coupler;
the audio signal processor is configured to transmit one of the third audio signal and the sixth audio signal to the outside; and
the switch is configured to switch an input to the audio signal processor between the third audio signal and the sixth audio signal based on the status of communication between the high-frequency coupler and the external high-frequency coupler.

5. A communication device comprising:
an audio signal processor configured to generate a seventh audio signal by reproducing audio information;
a high-frequency coupler configured to communicate with an external high-frequency coupler through electric field coupling by receiving an eighth audio signal, the eighth audio signal based on a high-frequency signal transmitted from the external high-frequency coupler;
an audio signal output section configured to output one of the seventh audio signal and the eighth audio signal; and
a switch configured to switch an output of the audio signal output section between the seventh audio signal and the eighth audio signal based on a status of communication between the high-frequency coupler and the external high-frequency coupler.

6. The communication device of claim 1, wherein the high-frequency coupler is configured to start to communicate with the external high-frequency coupler without authentication processing.

7. The communication device of claim 3, wherein the high-frequency coupler is configured to start to communicate with the external high-frequency coupler without authentication processing.

8. The communication device of claim 5, wherein the high-frequency coupler is configured to start to communicate with the external high-frequency coupler without authentication processing.
